(19) United States
(12) Patent Application Publication
(10) Pub. No.: US 2005/0116559 A1
(43) Pub. Date: Jun. 2, 2005

(54) 10SI alternator housing to accommodate larger improved heavy duty 17SI rectifier

(76) Inventor: Roy N. Karam, Saskatoon (CA)

Correspondence Address: ROY N. KARAM, 506 QUANCE AVE., SASKATOON, SK, S7H-3B4, CA

(21) Appl. No.: 10/724,199

(22) Filed: Dec. 1, 2003

(51) Int. Cl. H02M 1/00

(52) U.S. Cl. 310/68 D; 363/145

(57) ABSTRACT

High output popular small frame alternators have a high rate of failure due to higher heat temperatures typically caused by; 1) continuous higher rate charging, 2) lack of heat dissipation through rectifier heat sinks and diodes, 3) insufficient cooling (air exchange/air flow) through alternator and components, 4) the “plugging up” of alternator by foreign matter such as chaff, dust etc . . . as is common in agricultural, mining and industrial applications and therefore limiting cooling and causing “burn out”. The invention consists of an improved alternator Slip Ring End Housing (SRE) to allow for a larger and improved rectifier with larger heat sinks (and thus its exposed surface area) for increased heat dissipating capability and 9 50 amp diodes vs. the original 6 25 amp diodes representing a twinning of the positive diodes per phase (and thus increasing its current carrying capability) as well as an improved more open design in the housing and rectifier to allow for more air flow and a cooler running, more durable alternator.

### CROSS-REFERENCE TO RELATED APPLICATIONS

Not-Applicable

### STATEMENT REGARDING FEDERALLY SPONSORED RESEARCH OR DEVELOPMENT

Not-Applicable

### REFERENCE TO A MICROFICHE APPENDIX

Not-Applicable

### BACKGROUND OF THE INVENTION

The invention relates to popular small frame alternators used in many vehicular applications as well as stationary engines where the alternator is used to charge the battery to maintain sufficient operating voltage to power electrical accessories such as lights or a DC starter used to start a given engine.

The current trend for better fuel economy and efficiency is leading to increased demand on the electrical system. With the increased draw on the electrical system it becomes necessary to supply higher output alternators that can meet the additional electrical demand on the battery. And consequently, directly increasing the load on the alternator that has to maintain the power in the battery. High output popular small frame alternators on vehicles and machinery used in, automotive, industrial, agricultural and marine industries have a high rate of failure due to higher heat temperatures typically caused by; 1) continuous higher rate charging, 2) lack of heat dissipation through rectifier heat sinks and diodes, 3) insufficient cooling (air exchange/air flow) through alternator and components, 4) the “plugging up” of alternator by foreign matter such as chaff, dust etc . . . as is common in agricultural, mining and industrial applications and therefore limiting cooling and causing “burn out” predominantly in the rectifier-diodes assembly. The invention significantly improves reliability in high output popular small frame alternators by utilizing an improved slip ring end housing (rear housing) that can accomodate the installation of a larger improved rectifier-diode-heat sink assembly as well as increased air flow/exchange within the alternator to better dissipate the heat.

### BRIEF SUMMARY OF THE INVENTION

Briefly, the invention has the advantage over the conventional art rectifier and housing in that it achieves a cooler running and more reliable alternator. Specifically, consisting of an improved alternator SRE (slip ring end—rear housing) housing to allow for a larger improved rectifier with larger heat sinks and thus an increase in exposed surface area in which better heat dissipation can occur, as well enabling an increase in diode capacity to 9 50 amp diodes an additional advantage over the prior art rectifier containing only 6 25 amp diodes. The increase in number of diodes and per diode rating allows for a reliable increase in current carrying capability within the alternator. In addition, an improved more open design in the housing and rectifier allows for more air flow/exchange and a cooler running, more durable alternator.

### BRIEF DESCRIPTION OF THE SEVERAL VIEWS OF THE DRAWING

FIG. 1: Prior art. Depicts the front and back view of the conventional rectifier containing 6 diodes to be replaced.

FIG. 2: Depicts the front and back view of the larger and improved new heavy duty rectifier. Consisting of larger negative and positive heat sinks (2A), 9 50 amp diodes (2C) mounted on the larger heat sinks (2A), and 3 flow through air holes.

FIG. 3: Depicts the inside view of the redesigned housing to accommodate the new and larger heavy duty rectifier in FIG. 2. The smaller notches (3A) provide additional clearance enabling the use of the larger rectifier in FIG. 2. The protruding tabs (3B) allow for the proper grounding (contact) and mounting of the negative heat sink of the new rectifier depicted in FIG. 2.

FIG. 4: Depicts the back (outside) view of the redesigned housing to allow for the new and larger heavy duty improved rectifier.

FIG. 5: Depicts the inside view of the new and redesigned housing as a sub-assembly with the new heavy duty rectifier in FIG. 2 installed.

FIG. 6: Depicts the back view of the housing with the larger openings (6B) for better ventilation of the exposed diodes and heat sinks of the larger improved rectifier. Thru bolts (6A) are used to fasten the rectifier internally.

### DETAILED DESCRIPTION OF THE INVENTION

This invention relates to an improved alternator slip ring end housing (SRE) to allow for the installation of a larger enhanced, heavy duty rectifier that results in better heat dissipation and reliable higher output capability alternators.

It is common in high output small frame alternators to have a high rate of failure due to hotter temperatures developed in small frame alternators caused by; increased continuous high output charging capability, lack of heat dissipation through undersized rectifier heat sinks and diodes, insufficient cooling (air exchange/air flow) through alternator and components, and the plugging up of alternator by foreign matter such as chaff & dust, further limiting the cooling capabilities of the alternator.

We have found that the above factors contributing to early alternator failure can be overcome or significantly reduced. By redesigning the housing to allow for a larger rectifier with larger heat sinks and thus an increase in its exposed heat dissipating surface area and the utilization of 9 50 amp diodes versus the conventional 6 25 amp diodes (and thus increasing its current carrying capability) as well as an improved more open design in the housing and rectifier to allow for increased air flow for better cooling resulting in a cooler running, more durable alternator.

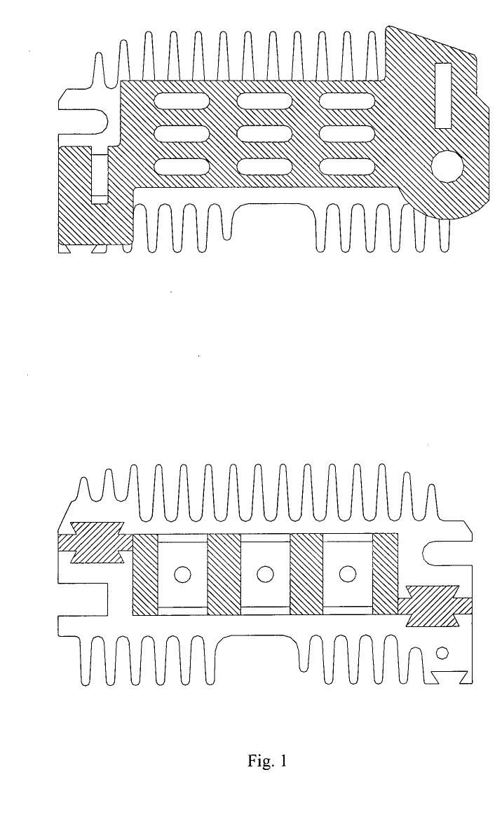

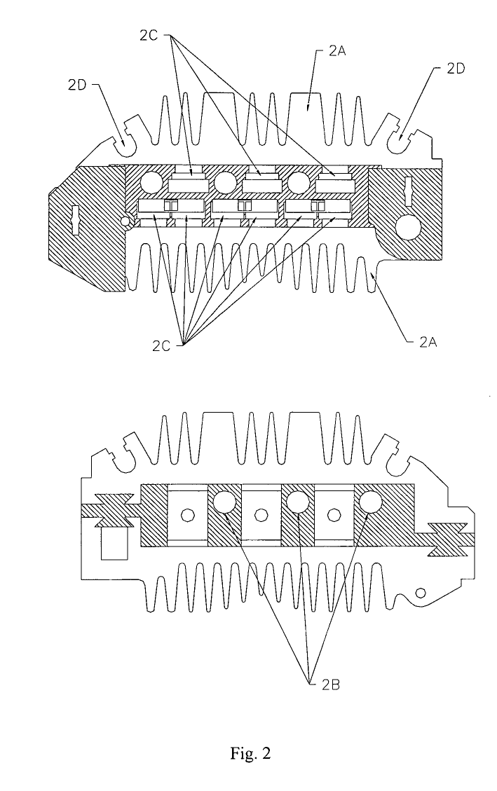

In pictures which illustrate the embodiments of the invention, FIG. 1 is the front and back view of the conventional prior art rectifier, which is comprised of 2 aluminum heat sinks, a positive and a negative heat sink each with 3 25 Amp diodes which are used to rectify the current produced within the alternator from AC (alternating current) to DC (direct current). FIG. 2 is the front and back view of the larger and improved heavy duty rectifier, which is comprised of 2 larger aluminum heat sinks (2A) and 6 twinned 50 Amp diodes (2C) on the positive heat sink as well as 3 50 Amp diodes (2C) on the negative heat sink. The twinning of the positive diodes and increase per diode (2C) rating to 50 Amps for both the positive and negative diodes mounted on larger heat sinks (2A) result in higher current handling capacity.

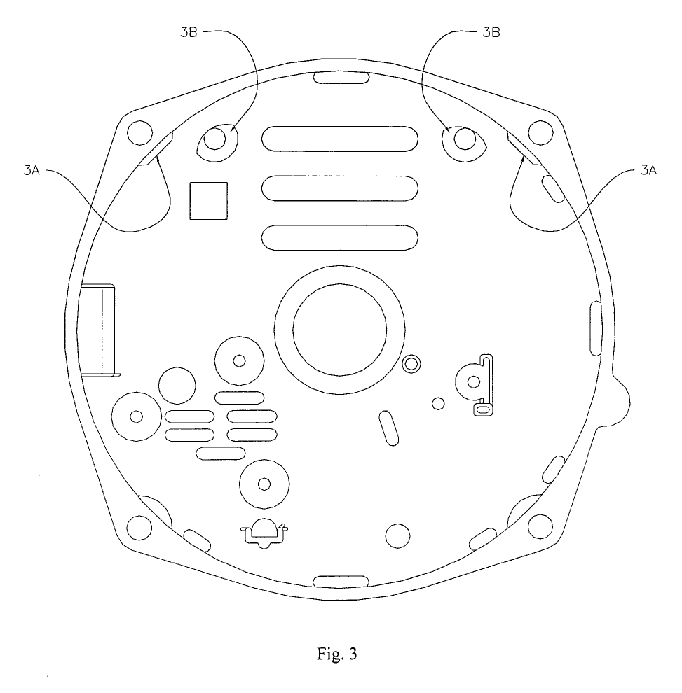

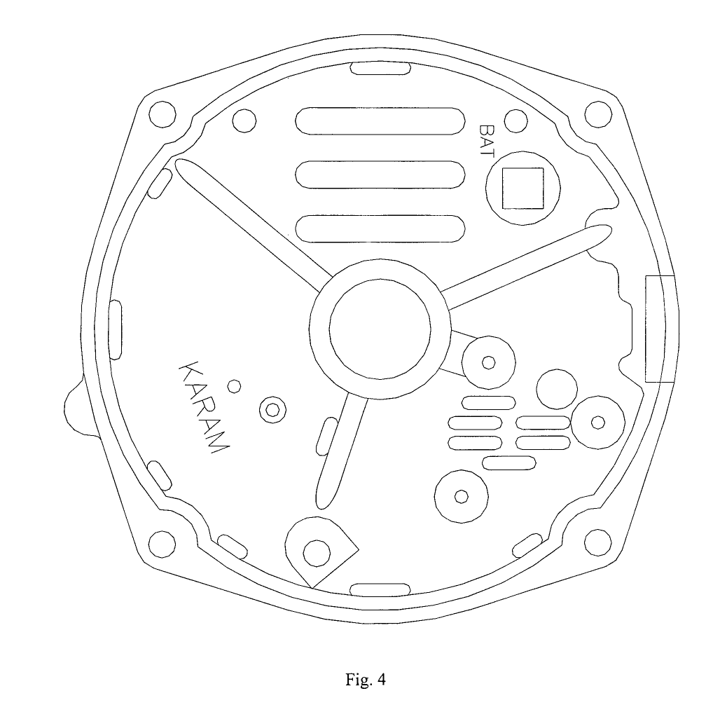

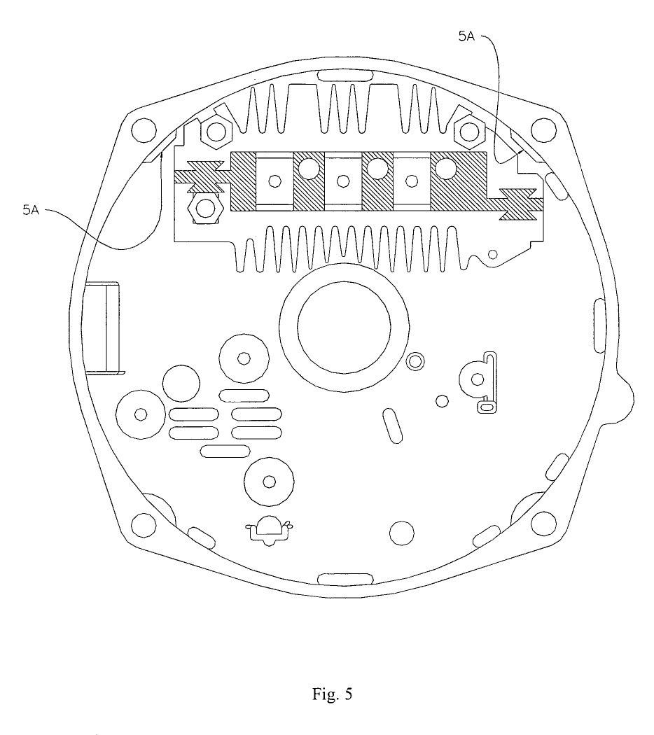

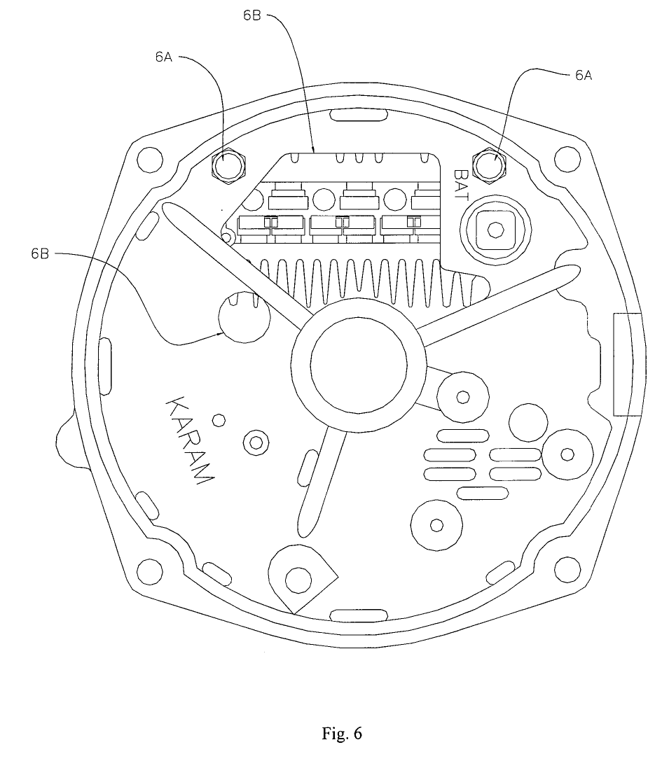

In addition, a more open design is incorporated as evident with the flow thru air holes (2B) that allow for additional air flow around the diodes contributing to cooler diodes through the exchange of cool and hot air. FIG. 3 is the inside view of the redesigned housing noting the addition of ground tabs (3B) for the proper grounding of the negative heat sink of the new larger rectifier (FIG. 2) and cleared notches (3A) enabling the installation of the larger and heavy duty rectifier in FIG. 2. FIG. 4 is the back outside view of the redesigned housing that allows for the installation of the larger improved rectifier. FIG. 5 is the inside view of the new housing with the new larger rectifier (FIG. 2) installed as a sub assembly. Notches (5A) in the housing allow for clearance to mount the larger rectifier (FIG. 2). FIG. 6 is the back view of the housing with the rectifier installed as an alternator sub assembly showing the large openings (6B) through which cool air is drawn in. The large openings (6B) significantly expose the diodes (2C) and heat sinks (2A) to cooler external air for better heat dissipation. Note the location of the thru bolts (6A) used to fasten the rectifier in the housing.

1. A slip ring end housing (FIG. 3 & 4) for an alternator, the slip ring end housing comprising of a predetermined length and width, an open first end, a second end and a sidewall extending therebetween, the second end of the slip ring end housing including a bearing well having an inner side and an outer side, and including a rectifier (FIG. 5), the improvement comprising: The said rectifier (FIG. 2) consisting of 9 button diodes (2C), 6 of which are twinned and soldered on the positive heat sink (2A) and 3 of which are soldered on the negative heat sink which is seated on dual protruding grounding tabs (3B).

2. The slip ring end housing of claim 1, wherein the said rectifier (FIG. 2) includes three air flow paths (2B) within the terminal block of the said rectifier (FIG. 2) which allow for the additional flow through of air around the diodes of the said rectifier consisting of 9 50 Amp button diodes (2C) 6 of which are twinned and soldered on the positive heat sink (2A) and 3 of which are soldered on the negative heat sink of an alternator.
